(19) United States
(12) Patent Application Publication
(10) Pub. No.: US 2017/0285874 A1
(43) Pub. Date: Oct. 5, 2017

(54) CAPTURE AND PROJECTION OF AN OBJECT IMAGE

(71) Applicant: Hewlett-Packard Development Company, L.P., Houston, TX (US)

(72) Inventors: Robert L Mueller, San Diego, CA (US); Ivan Dejesus Chousal, Chula Vista, CA (US); Ben Wynne, San Diego, CA (US)

(21) Appl. No.: 15/509,234

(22) PCT Filed: Sep. 8, 2014
(86) PCT No.: PCT/US2014/054453

§ 371 Date: Mar. 7, 2017

(51) Int. Cl. G06F 3/042; G06F 1/16; G06F 3/041

(52) U.S. Cl. CPC G06F 3/0425; G06F 3/0416; G06F 1/1639; G06F 1/1686

(57) ABSTRACT

An example system includes a camera to capture an image of an object on a surface, and a projector unit, communicatively coupled to the camera, to project the image of the object on the surface. The camera simultaneously generates a first trigger to the projector unit to switch display modes and a second trigger to a lighting source to disable light being projected onto the surface in response to an instruction to initiate capture of the image of the object.

### BACKGROUND

A capture system may be used to digitally capture images of documents and other objects and in an effort to improve the interactive user experience working with real objects and projected objects on a physical work surface. Further, a visual sensor is, a sensor that can capture visual data associated with a target, The visual data can include an image of the target or a video of the target. A cluster of heterogeneous visual sensors (different types of visual sensors) can be used for certain applications. Visual data collected by the heterogeneous sensors can be combined and processed to perform a task associated with the respective application.

### BRIEF DESCRIPTION OF THE DRAWINGS

For a detailed description of various examples, reference will now be made to the accompanying drawings in which:

FIG. 1 is a schematic perspective view of an example of a computer system in accordance with the principles disclosed herein;

FIG. 2 is another schematic perspective view of the computer system of FIG. 1 in accordance with the principles disclosed herein;

FIG. 3 is a schematic side view of the computer system of FIG. 1 in accordance with the principles disclosed herein;

FIG. 4 is a schematic front view of the computer system of FIG. 1 in accordance with the principles disclosed herein;

FIG. 5 is a schematic side view of the computer system of FIG. 1 during operation in accordance with the principles disclosed herein;

FIG. 6 is a schematic front view of the system of FIG. 1 during operation in accordance with the principles disclosed herein; and

FIG. 7 is a flow diagram depicting steps to implement an example.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof), a stylus, a pointing device, etc.

### DETAILED DESCRIPTION

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

Aspects of the present disclosure described herein disclose a projection capture system, which includes a digital camera and a projector unit. The projector functions both to illuminate objects in the camera in a capture area for image capture and to project digital images captured by the camera of those objects into a display area. Further, aspects of the present disclosure described herein disclose handling the digital image capture process with limited to no interactions with an operating system. Among other things, this approach allows the system to be easily portable to multiple operating systems. Moreover, among other things, the approach discussed herein reduces the digital image capture time from multiple seconds to less than one second. This results in an almost real-time user experience.

In one example in accordance with the present disclosure, a method for managing an image capture of an object is provided. The method comprises sending a message to a camera to initiate the capture of the image of the object, wherein in response to the message, the camera simultaneously provides a trigger to switch display mode of a projector, and another trigger to disable a lighting source, receiving the image of the object, and instructing to switch back the display mode of the projector, and to enable the lighting source.

In another example in accordance with the present disclosure, a system is provided. The system comprises a camera to capture an image of an object on a surface, and a projector unit, communicatively coupled to the camera, to project the image of the object on the surface. The camera simultaneously generates a first trigger to the projector unit to switch display modes and a second, trigger to a lighting source to disable light being projected onto the surface in response to an instruction to initiate capture of the image of the object.

In a further example in accordance with the present disclosure, another system is provided. The system comprises a projector unit attachable to project an image of an object on a touch sensitive mat, a computing device attachable to the projector unit, the touch sensitive mat communicatively coupled to the computing device, and a camera, communicatively coupled to the computing device, to capture the image of the object on the touch sensitive mat, wherein the camera simultaneously generates a trigger to the projector unit to switch display modes and to disable light being projected onto the touch sensitive mat in response to an instruction to capture the image of the object.

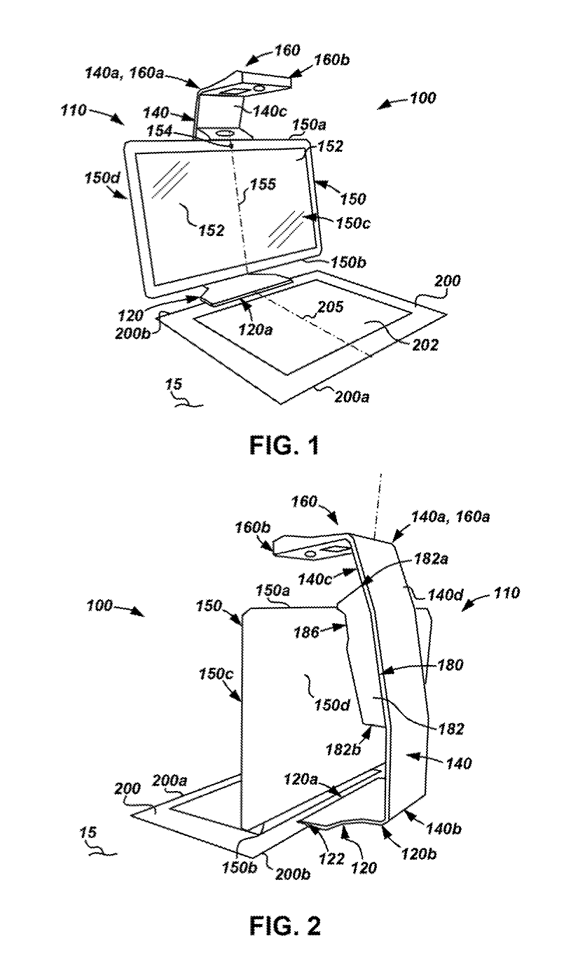

Referring now to FIGS. 1-4, a computer system 100 in accordance with the principles disclosed herein is shown. In this example, system 100 generally comprises a support structure 110, a computing device 150, a projector unit 180, and a touch sensitive mat 200. Computing device 150 may comprise any suitable computing device while still complying with the principles disclosed herein. For example, in some implementations, device 150 may comprise an electronic display, a smartphone, a tablet, an all-in-one computer (i.e., a display that also houses the computer's board), or some combination thereof. In this example, device 150 is an all-in-one computer that includes a central axis or center line 155, first or top side 150a, a second or bottom side 150b axially opposite the top side 150a, a front side 150c extending axially between the sides 150a, 150b, a rear side also extending axially between the sides 150a, 150b and generally radially opposite the front side 150c. A display 152 defines a viewing surface and is disposed along the front side 150c to project images for viewing and interaction by a user (not shown). In some examples, display 152 includes touch sensitive technology such as, for example, resistive, capacitive, acoustic wave, infrared (IR), strain gauge, optical, acoustic pulse recognition, or some combination thereof. Therefore, throughout the following description, display 152 may periodically be referred to as a touch sensitive surface or display. In addition, in some examples, device 150 further includes a camera 154 that is to take images of a user while he or she is positioned in front of display 152. In some implementations, camera 154 is a web camera. Further, in some examples, device 150 also includes a microphone or similar device that is arranged to receive sound inputs (e.g., voice) from a user during operation.

Referring still to FIGS. 1-4, support structure 110 includes a base 120, an upright member 140, and a top 160. Base 120 includes a first or front end 120a, and a second or rear end 120b. During operation, base 120 engages with a support surface 15 to support the weight of at least a portion of the components (e.g., member 140, unit 180, device 150, top 160, etc.) of system 100 during operation. In this example, front end 120a of base 120 includes a raised portion 122 that is slightly separated above the support surface 15 thereby creating a space or clearance between portion 122 and surface 15. As will be explained in more detail below, during operation of system 100, one side of mat 200 is received within the space formed between portion 122 and surface 15 to ensure proper alignment of mat 200. However, it should be appreciated that in other examples, other suitable alignments methods or devices may be used while still complying with the principles disclosed herein.

Upright member 140 includes a first or upper end 140a, a second or lower end 140b opposite the upper end 140a, a first or front side 140c extending between the ends 140a, 140b, and a second or rear side 140d opposite the front side 140c and also extending between the ends 140a, 140b. The lower end 140b of member 140 is coupled to the rear end 120b of base 120, such that member 140 extends substantially upward from the support surface 15.

Top 160 includes a first or proximate end 160a, a second or distal end 160b opposite the proximate end 160a, a top surface 160c extending between the ends 160a, 160b, and a bottom surface 160d opposite the top surface 160c and also extending between the ends 160a, 160b. Proximate end 160a of top 160 is coupled to upper end 140a of upright member 140 such that distal end 160b extends outward therefrom. As a result, in the example shown in FIG. 2, top 160 is supported only at end 160a and thus is referred to herein as a “cantilevered” top. In some examples, base 120, member 140, and top 160 are all monolithically formed; however, it should be appreciated that in other example, base 120, member 140, and/or top 160 may not be monolithically formed while still complying with the principles disclosed herein.

Referring still to FIGS. 1-4, mat 200 includes a central axis or centerline 205, a first or front side 200a, and a second or rear side 200b axially opposite the front side 200a. In this example, a touch sensitive surface 202 is disposed on mat 200 and, is substantially aligned with the axis 205. Surface 202 may comprise any suitable touch sensitive technology for detecting and tracking one or multiple touch inputs by a user in order to allow the user to interact with software being executed by device 150 or some other computing device (not shown). For example, in some implementations, surface 202 may utilize known touch sensitive technologies such as, for example, resistive, capacitive, acoustic wave, infrared, strain gauge, optical, acoustic pulse recognition, or some combination thereof while still complying with the principles disclosed herein. In addition, in this example, surface 202 extends over only a portion of mat 200; however, it should be appreciated that in other examples, surface 202 may extend over substantially all of mat 200 while still complying with the principles disclosed herein.

During operation, mat 200 is aligned with base 120 of structure 110, as previously described to ensure proper alignment thereof. In particular, in this example, rear side 200b of mat 200 is placed between the raised portion 122 of base 120 and support surface 15 such that rear end 200b is aligned with front side 120a of base, thereby ensuring proper overall alignment of mat 200, and particularly surface 202, with other components within system 100. In some examples, mat 200 is aligned with device 150 such that the center line 155 of device 150 is substantially aligned with center line 205 of mat 200; however, other alignments are possible. In addition, as will be described in more detail below, in at least some examples surface 202 of mat 200 and device 150 are electrically coupled to one another such that user inputs received by surface 202 are communicated to device 150. Any suitable wireless or wired electrical coupling or connection may be used between surface 202 and device 150 such as, for example, WI-FI, BLUETOOTH®, ultrasonic, electrical cables, electrical leads, electrical spring-loaded pogo pins with magnetic holding force, or some combination thereof, while still complying with the principles disclosed herein. In this example, exposed electrical contacts disposed on rear side 200b of mat 200 engage with corresponding electrical pogo-pin leads within portion 122 of base 120 to transfer signals between device 150 and surface 202 during operation. In addition, in this example, the electrical contacts are held together by adjacent magnets located in the clearance between portion 122 of base 120 and surface 15, previously described, to magnetically attract and hold (e.g., mechanically) a corresponding ferrous and/or magnetic material disposed along rear side 200b of mat 200.

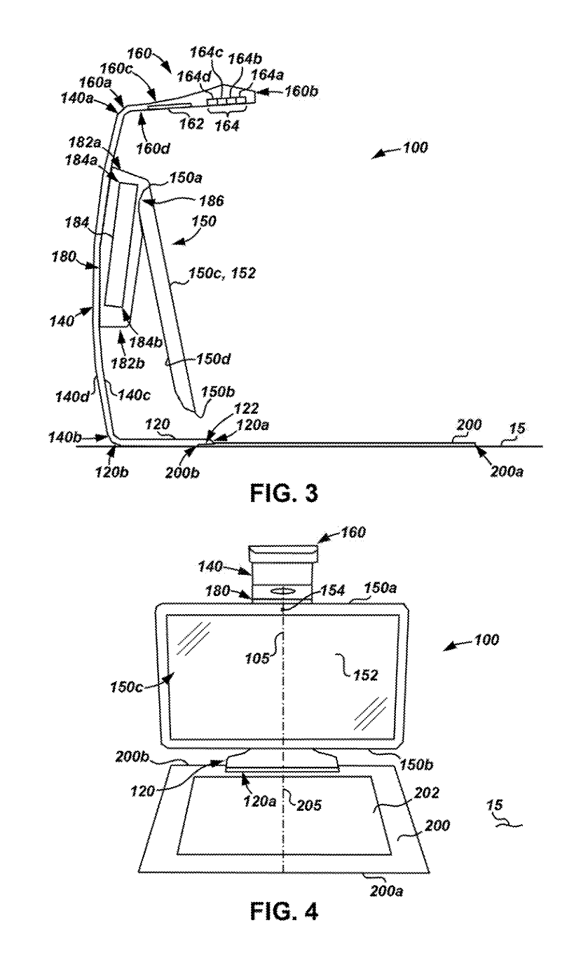

Referring specifically now to FIG. 3, projector unit 180 comprises an outer housing 182, and a projector assembly 184 disposed within housing 182. Housing 182 includes a first or upper end 182a, a second or lower end 182b opposite the upper end 182a, and an inner cavity 183. In this embodiment, housing 182 further includes a coupling or mounting member 186 to engage with ands support device 150 during operations. In general member 186 may be any suitable member or device for suspending and supporting a computer device (e.g., device 150) while still complying with the principles disclosed herein. For example, in some implementations, member 186 comprises hinge that includes an axis of rotation such that a user (not shown) may rotate device 150 about the axis of rotation to attain an optimal viewing angle therewith. Further, in some examples, device 150 is permanently or semi-permanently attached to housing 182 of unit 180. For example, in some implementations, the housing 180 and device 150 are integrally and/or monolithically formed as a single unit.

Thus, referring briefly to FIG. 4, when device 150 is suspended from structure 110 through the mounting member 186 on housing 182, projector unit 180 (i.e., both housing 182 and assembly 184) is substantially hidden behind device 150 when system 100 is viewed from a viewing surface or viewing angle that is substantially facing display 152 disposed on front side 150c of device 150. In addition, as is also shown in FIG. 4, when device 150 is suspended from structure 110 in the manner described, projector unit 180 (i.e., both housing 182 and assembly 184) and any image projected thereby is substantially aligned or centered with respect to the center line 155 of device 150.

Projector assembly 184 is generally disposed within cavity 183 of housing 182, and includes a first or upper end 184a, a second or lower end 184b opposite the upper end 184a. Upper end 184a is proximate upper end 182a of housing 182 while lower end 184b is proximate lower end 182b of housing 182. Projector assembly 184 may comprise any suitable digital light projector assembly for receiving data from a computing device (e.g., device 150) and projecting an image or images (e.g., out of upper end 184a) that correspond with that input data. For example, in some implementations, projector assembly 184 comprises a digital light processing (DLP) projector or a liquid crystal on silicon (LCoS) projector which are advantageously compact and power efficient projection engines capable of multiple display resolutions and sizes, such as, for example, standard XGA (1024×768) resolution 4:3 aspect ratio or standard WXGA (1280×800) resolution 16:10 aspect ratio. Projector assembly 184 is further electrically coupled to device 150 in order to receive data therefrom for producing light and images from end 184e during operation. In other implementations, system 100 may comprise an illumination system or light source separate from projector assembly 184. Projector assembly 184 may be electrically coupled to device 150 through any suitable type of electrical coupling while still complying with the principles disclosed herein. For example, in some implementations, assembly 184 is electrically coupled to device 150 through an electric conductor, WI-FI, BLUETOOTH®, an optical connection, an ultrasonic connection, or some combination thereof. In this example, device 150 is electrically coupled to assembly 184 through electrical leads or conductors (previously described) that are disposed within mounting member 186 such that when device 150 is suspended from structure 110 through member 186, the electrical leads disposed within member 186 contact corresponding leads or conductors disposed on device 150.

Referring still to FIG. 3, top 160 further includes a fold mirror 162 and a sensor bundle 164. Mirror 162 includes a highly reflective surface 162a that is disposed along bottom surface 160d of top 160 and is positioned to reflect images and/or light projected from upper end 184a of projector assembly 184 toward mat 200 during operation. Mirror 162 may comprise any suitable type of mirror or reflective surface while still complying with the principles disclosed herein. In this example, fold mirror 162 comprises a standard front surface vacuum metalized aluminum coated glass mirror that acts to fold light emitted from assembly 184 down to mat 200. In other examples, mirror 162 could have a complex aspherical curvature to act as a reflective lens element to provide additional focusing power or optical correction.

Sensor bundle 164 includes a plurality of sensors and/or cameras to measure and/or detect various parameters occurring on or near mat 200 during operation. For example, in the specific implementation depicted in FIG. 3, bundle 164 includes an ambient light sensor 164a, a camera (e.g., a color camera) 164b, a depth sensor or camera 164c, and a three dimensional (3D) user interface sensor 164d. Each sensor may have a different resolution and field of view. In one example, each of these sensors may be aimed at the horizontal touch sensitive mat 200 and touch sensitive surface 202 (e.g., screen for the projector). Accordingly, the field of views of these sensors may overlap.

Examples of applications in which sensor bundle 164 can be used include object detection, object tracking, object recognition, object classification, object segmentation, object capture and reconstruction, optical touch, augmented reality presentation, or other applications. Object detection can refer to detecting presence of an object in captured visual data, which can include an image or video. Object tracking can refer to tracking movement of the object. Object recognition can refer to identifying a particular object, such as identifying a type of the object, identifying a person, and so forth. Object classification can refer to classifying an object into one of multiple classes or categories. Object segmentation can refer to segmenting an object into multiple segments. Object capture and construction can refer to capturing visual data of an object and constructing a model of the object. Optical touch can refer to recognizing gestures made by a user's hand, a stylus, or other physical artifact that are intended to provide input to a system. The gestures are analogous to gestures corresponding to movement of a mouse device or gestures made on a touch-sensitive display panel. However, optical touch allows the gestures to be made in three-dimensional (3D) space or on a physical target that is not configured to detect user input.

Ambient light sensor 164a is arranged to measure the intensity of light of the environment surrounding system 100, in order to, in some implementations, adjust the camera's and/or sensor's (e.g., sensors 164a, 164b, 164c, 164d) exposure settings, and/or adjust the intensity of the light emitted from other sources throughout system such as, for example, projector assembly 184, display 152, etc. Camera 164b may, in some instances, comprise a color camera which is arranged to take either a still image or a video of an object and/or document disposed on mat 200. Depth sensor 164c generally indicates when a 3D object is on the work surface. In particular, depth sensor 164c may sense or detect the presence, shape, contours, motion, and/or the 3D depth of an object (or specific feature(s) of an object) placed on mat 200 during operation. Thus, in some implementations, sensor 164c may employ any suitable sensor or camera arrangement to sense and detect a 3D object and/or the depth values of each pixel (whether infrared, color, or other) disposed in the sensor's field-of-view (FOV). For example, in some implementations sensor 164c may comprise a single infrared (IR) camera sensor with a uniform flood of IR light, a dual IR camera sensor with a uniform flood of IR light, structured light depth sensor technology, time-of-flight (TOF) depth sensor technology, or some combination thereof. User interface sensor 164d includes any suitable device or devices (e.g., sensor or camera) for tracking a user input device such as, for example, a hand, stylus, pointing device, etc. In some implementations, sensor 164d includes a pair of cameras which are arranged to stereoscopically track the location of a user input device (e.g., a stylus) as it is moved by a user about the matt 200, and particularly about surface 202 of mat 200. In other examples, sensor 164d may also or alternatively include an infrared camera(s) or sensor(s) that is arranged to detect infrared light that is either emitted or reflected by a user input device. It should further be appreciated that bundle 164 may comprise other sensors and/or cameras either in lieu of or in addition to sensors 164a, 164b, 164c, 164d, previously described. In addition, as will explained in more detail below, each of the sensors 164a, 164b, 164c, 164d within bundle 164 is electrically and communicatively coupled to device 150 such that data generated within bundle 164 may be transmitted to device 150 and commands issued by device 150 may be communicated to the sensors 164a, 164b, 164c, 164d during operations. As is explained above for other components of system 100, any suitable electrical and/or communicative coupling may be used to couple sensor bundle 164 to device 150 such as for example, an electric conductor, WI-FI, BLUETOOTH®, an optical connection, an ultrasonic connection, or some combination thereof. In this example, electrical conductors are routed from bundle 164, through top 160, upright member 140, and projector unit 180 and into device 150 through the leads that are disposed within mounting member 186, previously described.

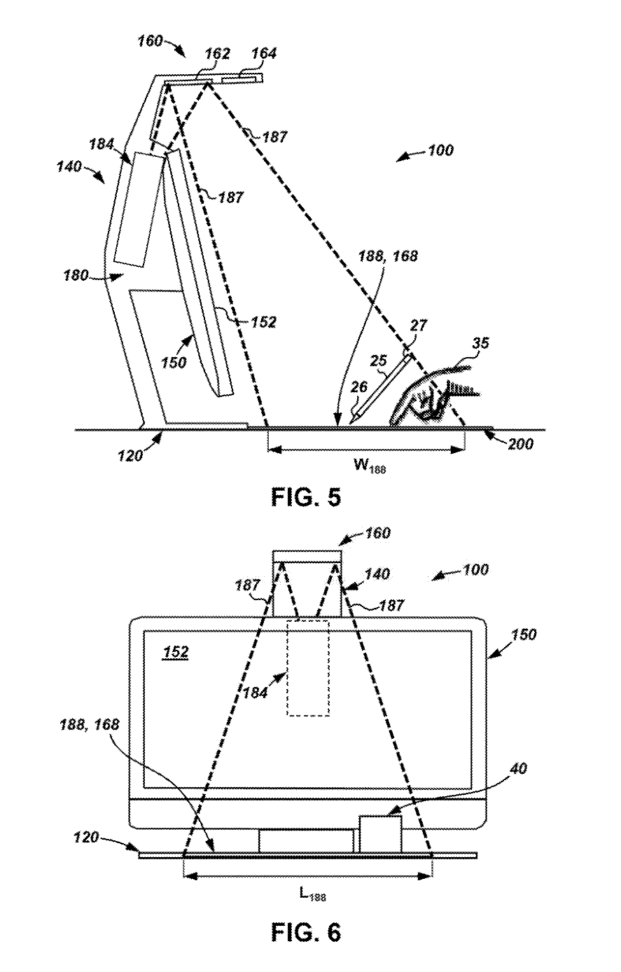

Referring now to FIGS. 5 and 6, during operation of system 100, light 187 is emitted from projector assembly 184, and reflected off of mirror 162 towards mat 200 thereby displaying an image on a projector display space 188. In this example, space 188 is substantially rectangular and is defined by a length L₁₈₈ and a width W₁₈₈. In some examples length L₁₈₈ may equal approximately 16 inches, while width W₁₈₈ may equal approximately 12 inches; however, it should be appreciated that other values for both length L₁₆₈ and width W₁₈₈ may be used while still complying with the principles disclosed herein. In addition, the sensors (e.g., sensors 164a, 164b, 164c, 164d) within bundle 164 include a sensed space 168 that, in at least some examples, overlaps and/or corresponds with projector display space 188, previously described. Space 168 defines the area that the sensors within bundle 164 are arranged to monitor and/or detect the conditions thereof in the manner previously described. In some examples, both space 188 and space 168 coincide or correspond with surface 202 of mat 200, previously described, to effectively integrate the functionality of the touch sensitive surface 202, projector assembly 184, and sensor bundle 164 within a defined area.

Referring still to FIGS. 5-6, in addition, during operation of at least some examples, system 100 may capture a two dimensional (2D) image or create a 3D scan of a physical object such that an image of the object may then be projected onto the surface 202 for further use and manipulation thereof. In particular, in some examples, an object 40 may be placed on surface 202 such that sensors (e.g., camera 164b, depth sensor 164c, etc.) within bundle 164 may detect, for instance, the location, dimensions, and in some instances, the color of object 40, to enhance a 2D image or create a 3D scan thereof based on the detected information. The information gathered by the sensors (e.g., sensors 164b, 164c) within bundle 164 may then be routed to processor of device 150. Thereafter, the processor directs projector assembly 184 to project an image of object 40 onto the surface 202. In one implementation, the object can be a two dimensional object (e.g., a hardcopy photograph). In another implementation, the object can be a three dimensional object (e.g., a cube).

More specifically, images of physical objects (e.g., object 40) may be captured, digitized, and displayed on surface 202 during operation to quickly and easily create a digital version of a physical object. For example, a user of system 100 may request to capture a digital image of object 40. The request may be received via a controller. Camera 164b and projector assembly 184 may be operatively connected to the controller, and the controller may be programmed to generate project a user control panel, including device control “buttons” such as capture button and undo, fix, and OK buttons. In another implementation, the control panel may be embedded in mat 200. Further, in response to the capture request, a message (e.g., USB message) may be generated and sent to camera 164b. Based on the received message, the camera triggers a hardware function in projector assembly 184 to switch display modes. Simultaneously, the camera also triggers to disable the lighting source providing light 187. As discussed earlier, the lighting source may be internal to projector assembly 184, or the lighting source may be a separate illumination system. Further, when the camera completes capturing the digital image, the lighting source may be reactivated and the display mode may be switched back.

In addition to viewing and/or manipulating a digital image of a physical object on a display surface of a computing device (e.g., display 152 and/or surface 202), a digital shared workstation for remotely positioned users be created. Through use of a computer system 100 in accordance with the principles disclosed herein, the physical content may be scanned, digitized, and shared among all concurrent users of the digital collaboration workstation, and user interaction with the digital content and/or physical objection is visible by all participants.

Further, in, some examples, sensors disposed within bundle 164 (e.g., sensors 164a, 164b, 164c, 164d) may also generate system input which is routed to device 150 for further processing by a processor. For example, in some implementations, sensors within bundle 164 may capture an image of an object positioned on surface 202 and then generate an input signal which is routed to the processor. The processor then generates a corresponding output signal which is routed to display 152 and/or projector assembly 184 in the manner described above. In particular, in some implementations, bundle 164 includes a pair of cameras or sensors that are arranged to perform stereoscopic stylus tracking.

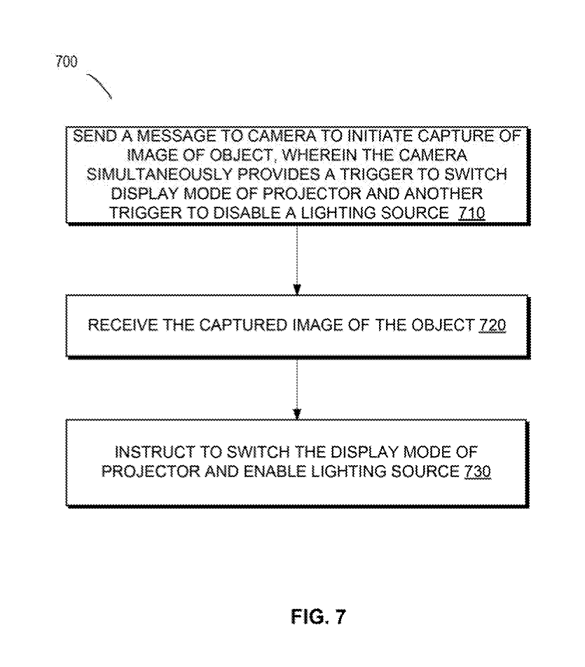

Turning now to the operation of system 100, FIG. 7 is a flowchart of an example method 700 in accordance with an example implementation. It should be readily apparent that the processes depicted in FIG. 7 represent generalized illustrations, and that other processes may be added or the illustrated processes may be removed, modified, or rearranged in many ways. Further, it should be understood that the processes may represent executable instructions stored on memory that may cause a processing device to respond, to perform actions, to change states, and/or to make decisions, for instance. Thus, the described processes may be implemented as executable instructions and/or operations provided by a memory associated with the computing device 100.

The illustrated process 700 begins at block 710. At 710, a message is sent to camera to initiate capture of an image of an object. In one implementation, the message may be a USB message. In response to this message, the camera simultaneously provides a trigger to switch display mode of a projector, and another trigger to disable a lighting source. At 720, the capture is performed and the image of the object is received. At 730, instructions are generated to switch back the display mode of the projector and to enable the lighting source.

Although the flowchart of FIG. 7 shows a specific order of performance of certain functionalities, method 700 is not limited to that order. For example, the functionalities shown in succession in the flowchart may be performed in a different order, may be executed concurrently or with partial concurrence, or a combination thereof. In some examples, features and functionalities described herein in relation to FIG. 7 may be provided in combination with features and functionalities described herein in relation to any of FIGS. 1-6.

While device 150 has been described as an all-in-one computer, it should be appreciated that in other examples, device 150 may further employ the use of more traditional user input devices such as, for example, a keyboard and a mouse. In addition, while sensors 164a, 164b, 164c, 164d within bundle 164 have been described as each representing a single sensor or camera, it should be appreciated that each of the sensors 164a, 164b, 164c, 164d may each include multiple sensors or cameras while still complying with the principles described herein. Further, while top 160 has been described herein as a cantilevered top, it should be appreciated that in other examples, top 160 may be supported at more than one point and is thus may not be cantilevered while still complying with the principles disclosed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a camera to capture an image of an object on a surface: and
a projector unit, communicatively coupled to the camera, to project the image of the object on the surface;
wherein the camera simultaneously generates a first trigger to the projector unit to switch display modes and a second trigger to a lighting source to disable light being projected onto the surface in response to an instruction to initiate capture of the image of the object.

2. The system of claim 1, further comprising a computing device, to provide the instruction to initiate the capture of the image of the object to the camera.

3. The system of claim 2, wherein the computing device generates and sends a message to the camera, the message including instruction to initiate the capture of the image of the object.

4. The system of claim 2, wherein the computing device receives a request to capture the image of the object via a control panel.

5. The system of claim 4, wherein the control panel comprises control buttons including a capture button.

6. The system of claim 4, wherein the control panel is embedded in the surface.

7. The system of claim 1, wherein the lighting source is housed in the projector unit.

8. The system of claim 1, wherein the projector unit switches back the display modes and the lighting source is enabled upon completion of capture of the image of the object.

9. The system of claim 2, wherein the computing device is to cause the camera to scan the object on the surface to produce the image and then to cause the projector unit to project the image back on to the surface.

10. The system of claim 1 further comprising an electrical connection between the surface and the computing device through a base.

11. A processor-implemented method for managing a capture of an image of an object, comprising:
sending a message to a camera to initiate the capture of the image of the object, wherein in response to the message, the camera simultaneously provides a trigger to switch display mode of a projector, and another trigger to disable a lighting source;
receiving the image of the object; and
instructing to switch back the display mode of the projector, and to enable the lighting source.

12. Thee processor-implemented method of claim 11, further comprising generating the message in response to a request to capture the image of the object.

13. The processor-implemented method of claim 12, wherein the request is received via a control panel generated by a controller that the camera and projector are operatively connected.

14. A system, comprising:
a projector unit attachable to project an image of an object on a touch sensitive mat;
a computing device attachable to he projector unit;
the touch sensitive mat communicatively coupled to the computing device; and
a camera, communicatively coupled to the computing device, to capture the image of the object on the touch sensitive mat, wherein the camera simultaneously generates a trigger to the projector unit to switch display modes and to disable light being projected onto the touch sensitive mat in response to an instruction to capture the image of the object.

15. The system of claim 14, wherein the camera completes capturing the image of the object with limited interaction with the computing device.
